(19) United States
(12) Patent Application Publication
(10) Pub. No.: US 2025/0192841 A1
(43) Pub. Date: Jun. 12, 2025

(54) NON-ORTHOGONAL DISCRETE FOURIER TRANSFORM CODEBOOKS FOR CHANNEL STATE INFORMATION SIGNALS

(71) Applicant: QUALCOMM Incorporated, San Diego, CA (US)

(72) Inventors: Jing DAI, Beijing (CN); Liangming WU, Beijing (CN); Chenxi HAO, Beijing (CN); Chao WEI, Beijing (CN); Min HUANG, Beijing (CN); Wei XI, Beijing (CN); Hao XU, Beijing (CN)

(21) Appl. No.: 18/842,250

(22) PCT Filed: Apr. 21, 2022
(86) PCT No.: PCT/CN2022/088088

§ 371 Date: Aug. 28, 2024

(51) Int. Cl. H04B 7/06; H04W 24/10

(52) U.S. Cl. CPC H04B 7/0626; H04B 7/0639; H04W 24/10

(57) ABSTRACT

Various aspects of the present disclosure generally relate to wireless communication. In some aspects, a user equipment (UE) may receive a configuration associated with a non-orthogonal discrete Fourier transform (DFT) codebook for channel state information (CSI) in a time domain. Accordingly, the UE may transmit a CSI report based at least in part on the non-orthogonal DFT codebook. Numerous other aspects are described.

### FIELD OF THE DISCLOSURE

Aspects of the present disclosure generally relate to wireless communication and to techniques and apparatuses for configuring and using non-orthogonal discrete Fourier transform codebooks for channel state information signals.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration associated with a non-orthogonal discrete Fourier transform (DFT) codebook for channel state information (CSI) in a time domain. The method may further include transmitting a CSI report based at least in part on the non-orthogonal DFT codebook.

Some aspects described herein relate to an apparatus for wireless communication at a UE. The apparatus may include a memory and one or more processors coupled to the memory. The one or more processors may be configured to receive a configuration associated with a non-orthogonal DFT codebook for CSI in a time domain. The one or more processors may be further configured to transmit a CSI report based at least in part on the non-orthogonal DFT codebook.

Some aspects described herein relate to a non-transitory computer-readable medium that stores a set of instructions for wireless communication by a UE. The set of instructions, when executed by one or more processors of the UE, may cause the UE to receive a configuration associated with a non-orthogonal DFT codebook for CSI in a time domain. The set of instructions, when executed by one or more processors of the UE, may further cause the UE to transmit a CSI report based at least in part on the non-orthogonal DFT codebook.

Some aspects described herein relate to an apparatus for wireless communication. The apparatus may include means for receiving a configuration associated with a non-orthogonal DFT codebook for CSI in a time domain. The apparatus may further include means for transmitting a CSI report based at least in part on the non-orthogonal DFT codebook.

Some aspects described herein relate to a method of wireless communication performed by a network entity. The method may include transmitting a configuration associated with a non-orthogonal DFT codebook for CSI in a time domain. The method may further include receiving a CSI report based at least in part on the non-orthogonal DFT codebook.

Some aspects described herein relate to an apparatus for wireless communication at a network entity. The apparatus may include a memory and one or more processors coupled to the memory. The one or more processors may be configured to transmit a configuration associated with a non-orthogonal DFT codebook for CSI in a time domain. The one or more processors may be further configured to receive a CSI report based at least in part on the non-orthogonal DFT codebook.

Some aspects described herein relate to a non-transitory computer-readable medium that stores a set of instructions for wireless communication by a network entity. The set of instructions, when executed by one or more processors of the network entity, may cause the network entity to transmit a configuration associated with a non-orthogonal DFT codebook for CSI in a time domain. The set of instructions, when executed by one or more processors of the network entity, may further cause the network entity to receive a CSI report based at least in part on the non-orthogonal DFT codebook.

Some aspects described herein relate to an apparatus for wireless communication. The apparatus may include means for transmitting a configuration associated with a non-orthogonal DFT codebook for CSI in a time domain. The apparatus may further include means for receiving a CSI report based at least in part on the non-orthogonal DFT codebook.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of disaggregated base station architecture, in accordance with the present disclosure.

FIGS. 4A and 4B are diagrams illustrating an example of compressing a coefficient matrix into a Doppler domain, in accordance with the present disclosure.

FIG. 5 is a diagram illustrating an example associated with a non-orthogonal discrete Fourier transform (DFT) codebook for channel state information (CSI) in a time domain, in accordance with the present disclosure.

FIG. 6 is a diagram illustrating an example associated with configuring a non-orthogonal DFT codebook for CSI in a time domain, in accordance with the present disclosure.

FIG. 7 is a diagram illustrating an example associated with a starting slot for a non-orthogonal DFT codebook for CSI in a time domain, in accordance with the present disclosure.

FIGS. 8A and 8B are diagrams illustrating examples associated with an observation window for a non-orthogonal DFT codebook for CSI in a time domain, in accordance with the present disclosure.

FIGS. 9A, 9B, and 9C are diagrams illustrating examples associated with CSI reference signal (CSI-RS) instances for a non-orthogonal DFT codebook for CSI in a time domain, in accordance with the present disclosure.

FIGS. 10 and 11 are diagrams illustrating example processes associated with configuring and using non-orthogonal DFT codebooks for CSI signals, in accordance with the present disclosure.

FIGS. 12 and 13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

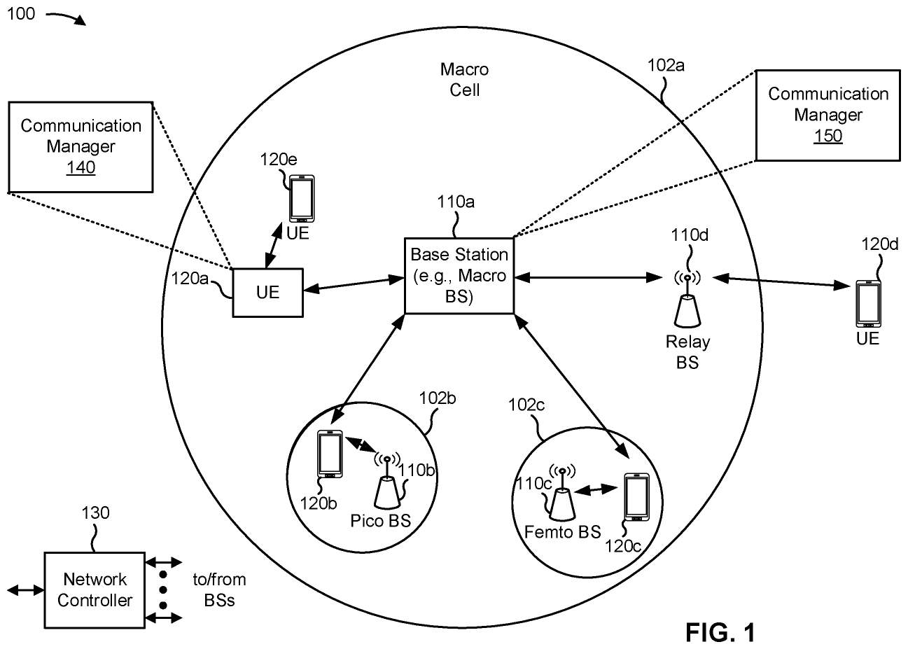

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

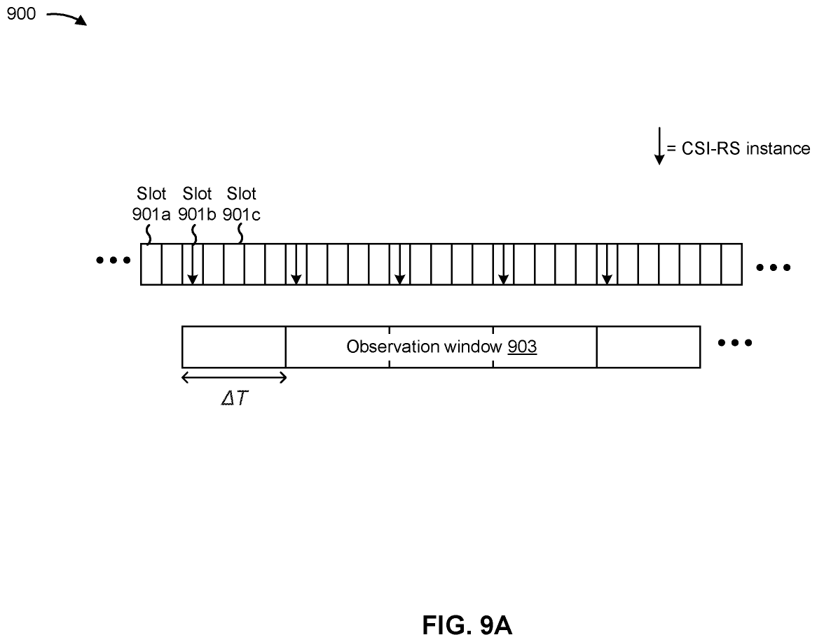

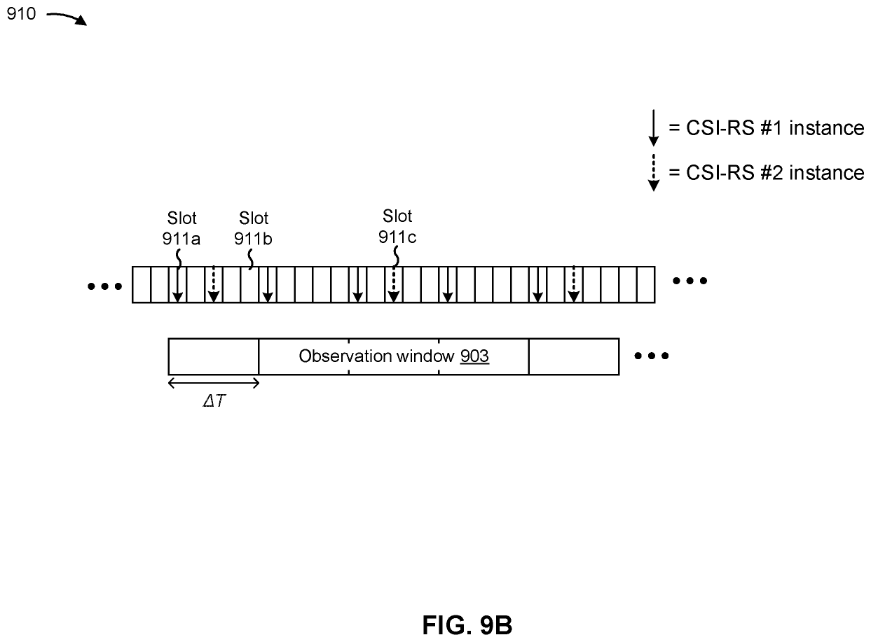

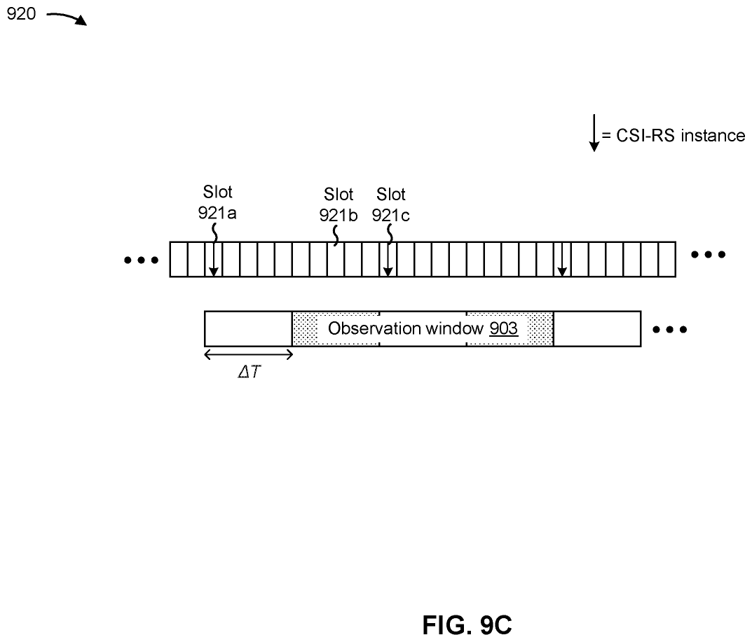

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHZ” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration associated with a non-orthogonal discrete Fourier transform (DFT) codebook for channel state information (CSI) in a time domain and transmit a CSI report based at least in part on the non-orthogonal DFT codebook. Additionally, or alternatively, the communication manager 140 may perform one or more other operations described herein.

In some aspects, a network entity (e.g., the base station 110) may include a communication manager 150. As described in more detail elsewhere herein, the communication manager 150 may transmit a configuration associated with a non-orthogonal DFT codebook for CSI in a time domain; and receive a CSI report based at least in part on the non-orthogonal DFT codebook. Additionally, or alternatively, the communication manager 150 may perform one or more other operations described herein.

As indicated above, FIG. 1 is provided as an example. Other examples may differ from what is described with regard to FIG. 1.

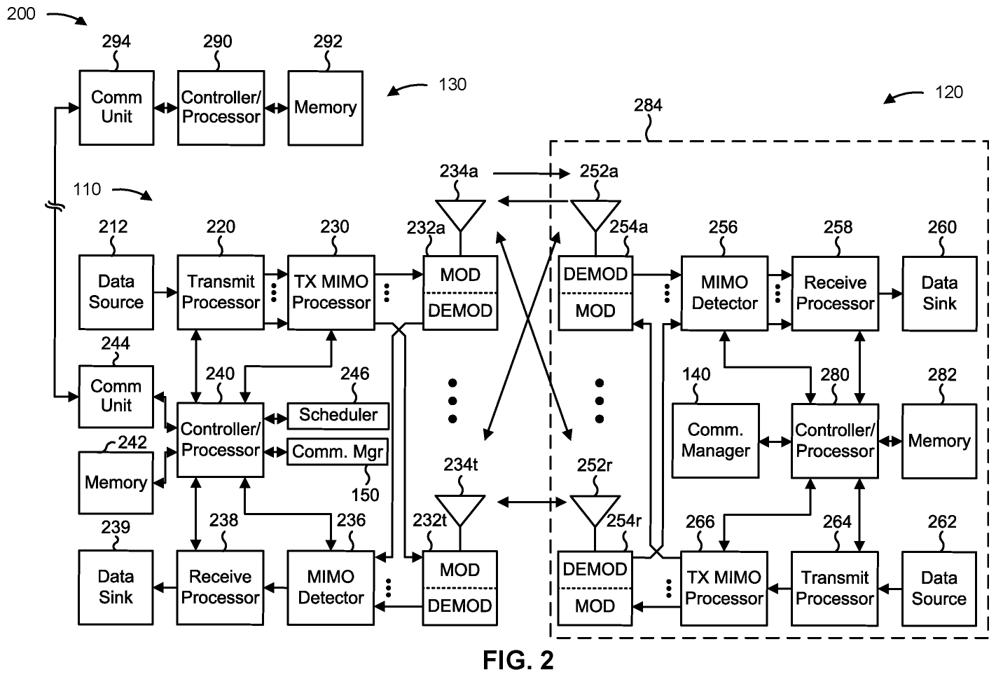

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

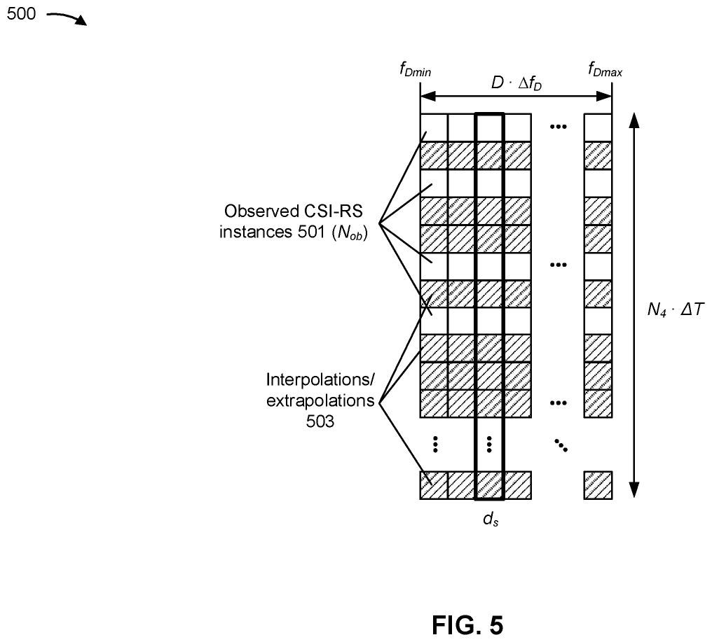

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-13).

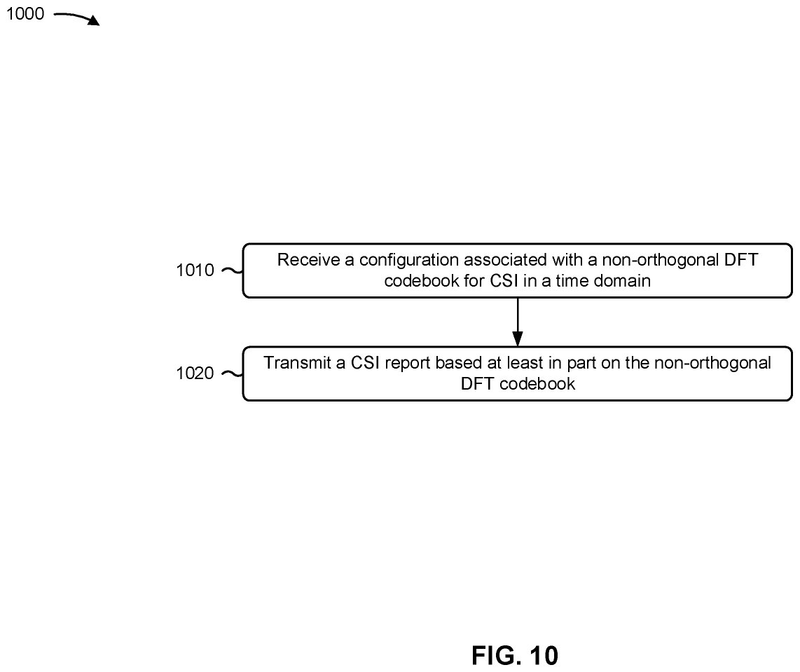

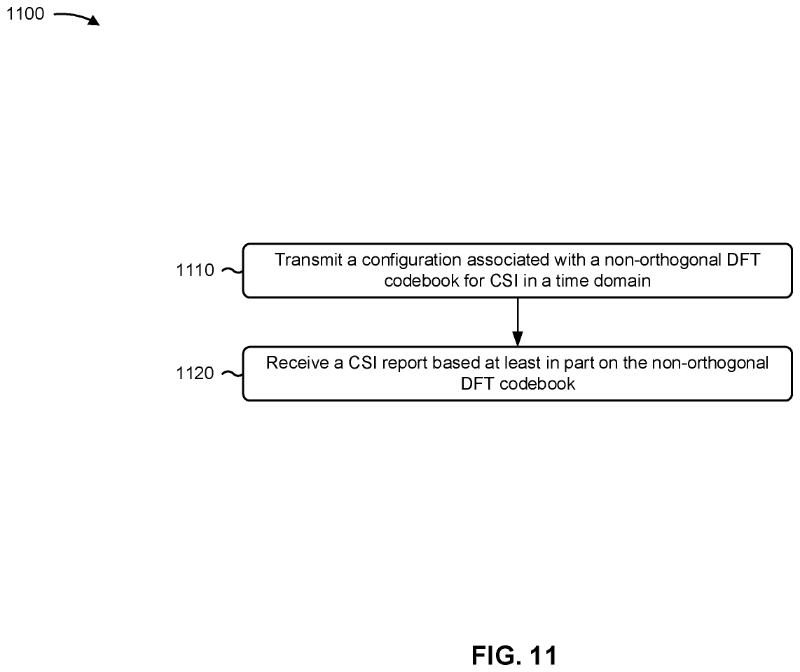

The controller/processor 240 of the base station 110, the controller/processor 280 of the UE 120, and/or any other component(s) of FIG. 2 may perform one or more techniques associated with configuring and using non-orthogonal DFT codebooks for CSI signals, as described in more detail elsewhere herein. For example, the controller/processor 240 of the base station 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples. In some aspects, the network entity described herein is the base station 110, is included in the base station 110, or includes one or more components of the base station 110 shown in FIG. 2.

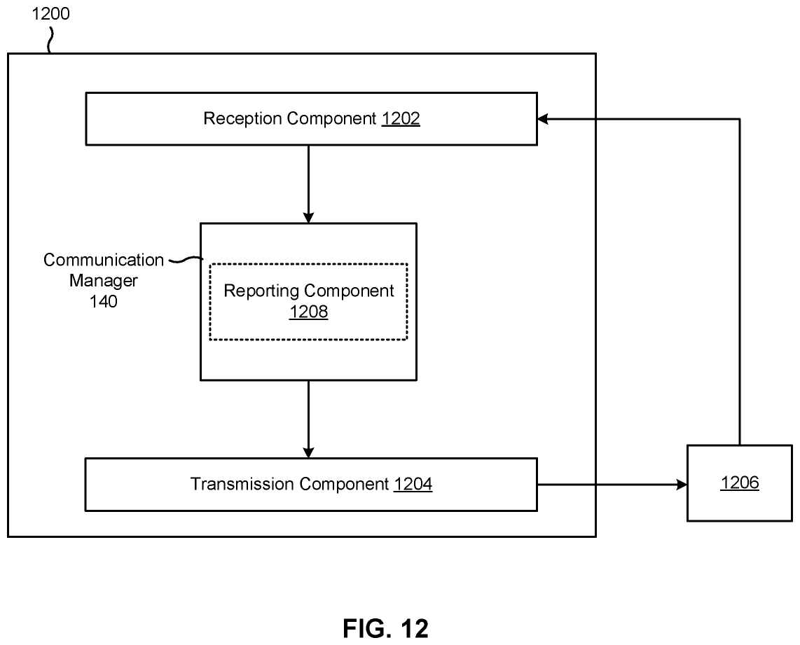

In some aspects, a UE (e.g., UE 120 and/or apparatus 1200 of FIG. 12) may include means for receiving a configuration associated with a non-orthogonal DFT codebook for CSI in a time domain; and/or means for transmitting a CSI report based at least in part on the non-orthogonal DFT codebook. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

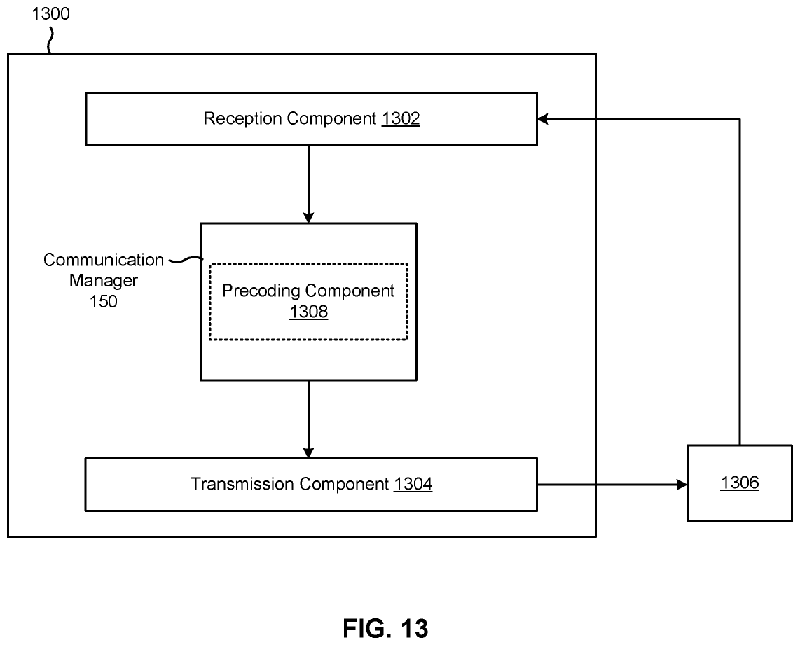

In some aspects, a network entity (e.g., base station 110, CU 310, DU 330, RU 340, and/or apparatus 1300 of FIG. 13) may include means for transmitting a configuration associated with a non-orthogonal DFT codebook for CSI in a time domain; and/or means for receiving a CSI report based at least in part on the non-orthogonal DFT codebook. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

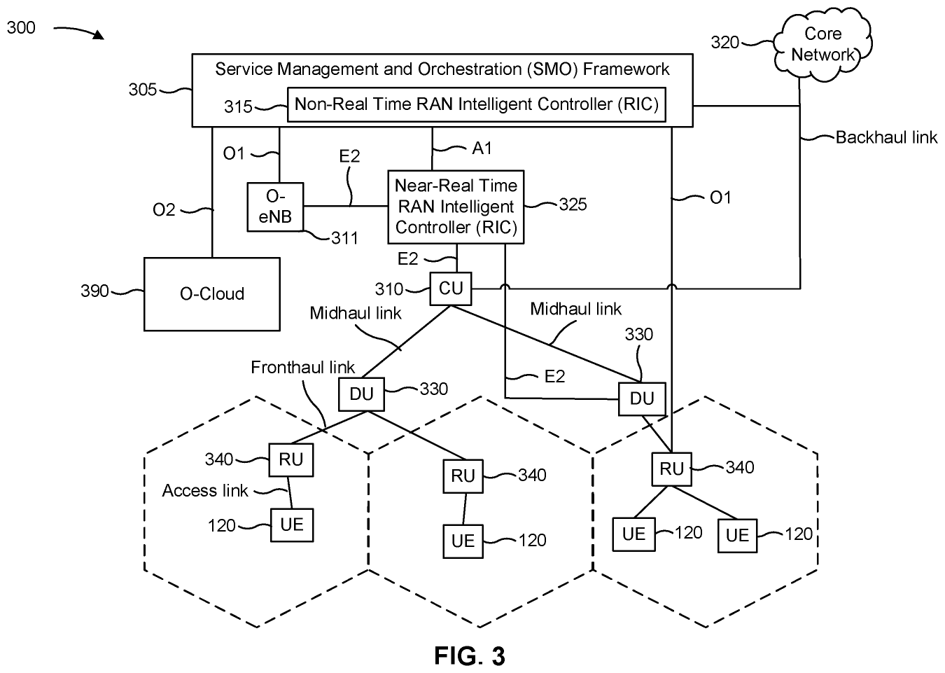

FIG. 3 is a diagram illustrating an example 300 disaggregated base station architecture, in accordance with the present disclosure. Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

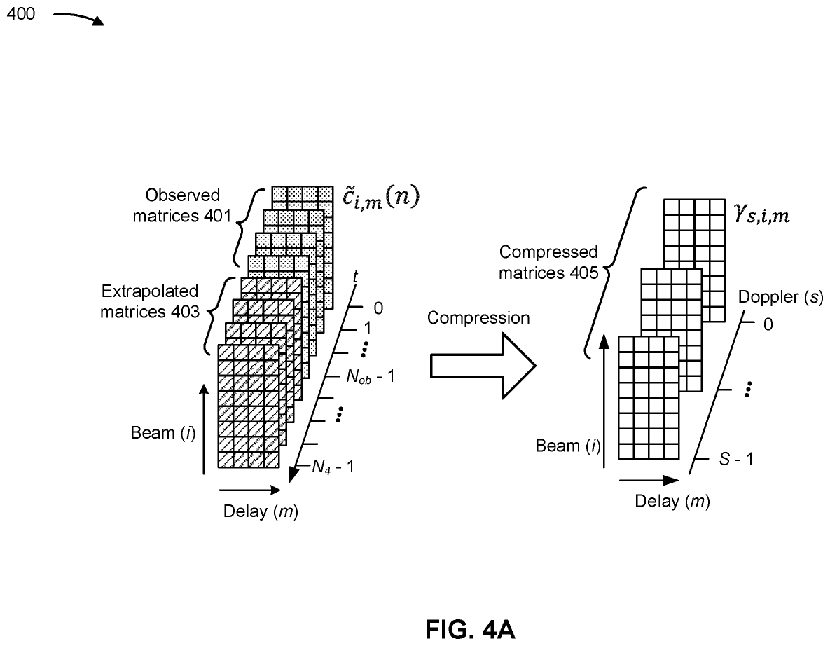

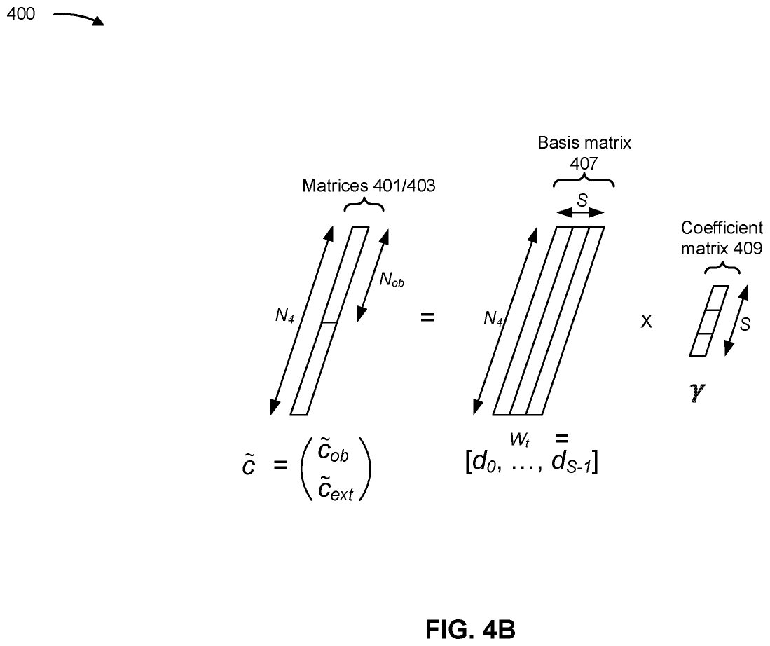

FIGS. 4A and 4B are diagrams illustrating an example 400 of compressing a coefficient matrix into a Doppler domain, in accordance with the present disclosure. A network entity precodes signals in order to distribute the signals across antennas of the network entity. Generally, a precoding matrix (e.g., represented by W) may be determined using spatial domain bases (e.g., represented by W₁), frequency domain bases (e.g., represented by W_{f}^{H}), and a coefficient matrix (e.g., represented by \tilde{W}₂). For example, W=W₁×\tilde{W}₂×W_{f}^{H}.

When a UE is moving relatively quickly and/or when a channel between the network entity and the UE is changing relatively quickly, the precoding matrix \tilde{W}₂(n) may vary over time (where n represents an instance or bin within a time domain). As shown in FIG. 4A, the precoding matrix also be represented by \tilde{c}_{i,m}(n) (where i represents a beam and m represents a subcarrier). A “subcarrier” may refer to a frequency based at least in part on a “carrier” frequency, and subcarriers may be aggregated to convey information wirelessly (e.g., using OFDM symbols and/or other RF symbols). The quantity of beams being used may be represented by 2L, such that i ranges from 0 to 2L−1. Additionally, the quantity of subcarriers being aggregated may be represented by M such that m ranges from 0 to M−1.

As further shown in FIG. 4 and by reference number 401, the coefficient matrix may vary over observed instances in time (e.g., observed CSI reference signal (CSI-RS) instances). The quantity of bins with observed instances may be represented by N_{ob} such that n ranges from 0 to N_{ob}−1. Additionally, as shown by reference number 403, the coefficient matrix may vary over extrapolated instances in time (e.g., without measurements of CSI-RSs by the UE). The total quantity of bins, including observed instances and extrapolated instances, may be represented by N₄ such that n ranges from 0 to N₄−1.

In order to compress the coefficient matrix in time, as shown by reference number 405, the UE may determine compressed matrices γ_{s,i,m} (where s represents a Doppler instance that ranges from 0 to S−1 and S<N₄). By compressing the coefficient matrices, the UE reduces a size of a corresponding CSI report transmitted to the network entity.

As shown in FIG. 4B, in order to compress the coefficient matrices, the UE may use a basis matrix 407 and a coefficient matrix 409. The coefficient matrices may include a combination of observed values \tilde{c}_{ob} and extrapolated values \tilde{c}ₑₓₜ. The basis matrix 407 may be represented by Wₜ and may include bases represented by d₀, . . . , d_{S-1}. The basis matrix 407 may have a first dimension equal to the total quantity of bins N₄ for the coefficient matrix and a second dimension equal to the quantity of Doppler instances S. The coefficient matrix 409 may be represented by γ and may have a dimension equal to the quantity of Doppler instances S. Accordingly, the UE may estimate precoding matrices and compress the estimated precoding matrices using the basis matrix 407 such that the UE 120 may generate the CSI report with the coefficient matrix 409 to reduce size and thus reduce network overhead.

Generally, to increase accuracy of the CSI report, the network entity and the UE should increase Doppler domain granularity of the basis matrix Wₜ. However, to increase the Doppler domain granularity, the network entity transmits, and the UE receive, additional CSI-RS instances in order to increase dimensions of the basis matrix Wₜ.

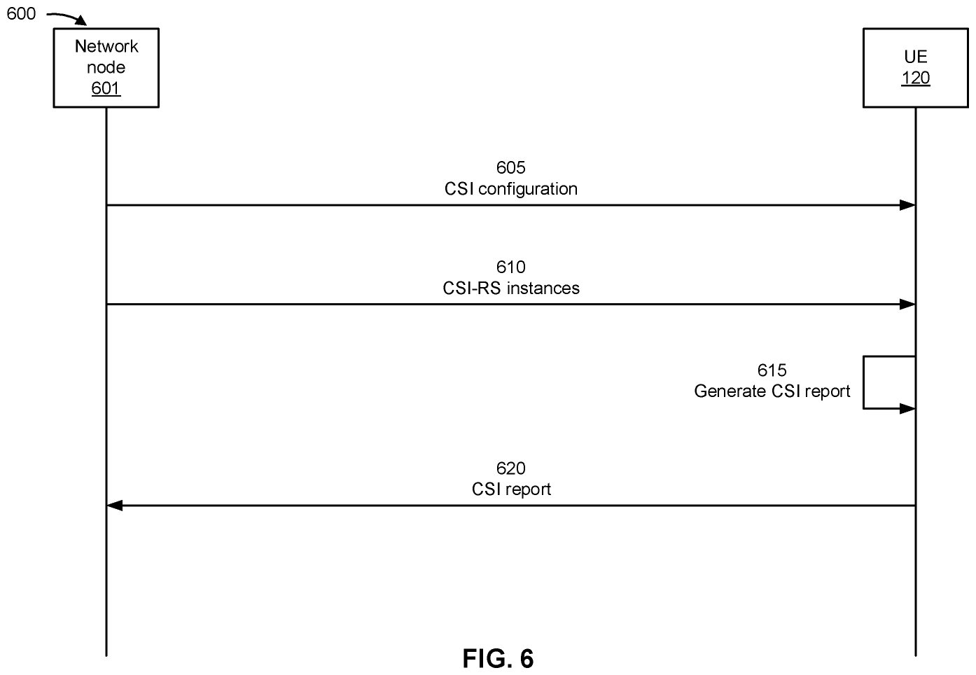

Some techniques and apparatuses described herein enable a network entity (e.g., network entity 601 of FIG. 6) to configure a non-orthogonal DFT codebook for CSI in a time domain. For example, the network entity 601 may configure a basis matrix Wₜ with an oversampling of frequency bases. As a result, a UE (e.g., the UE 120) may use Doppler compression to reduce a size of a corresponding CSI report transmitted to the network entity 601 (and thus reduce network overhead associated with the CSI report). Additionally, the UE 120 increases accuracy of the CSI report by increasing Doppler domain granularity while conserving power and processing resources at the network entity 601 and the UE 120 that would otherwise have been used to transmit and receive, respectively, additional CSI-RSs.

As indicated above, FIGS. 4A and 4B are provided as an example. Other examples may differ from what is described with respect to FIGS. 4A and 4B.

FIG. 5 is a diagram illustrating an example 500 associated with a non-orthogonal DFT codebook for CSI in a time domain, in accordance with the present disclosure. As shown in FIG. 5, a UE (e.g., the UE 120) may use a codebook that includes include basis entries associated with observed CSI-RS instances 501 and basis entries associated with interpolations and/or extrapolations 503. Accordingly, the UE 120 may determine a coefficient matrix for a CSI report using the codebook and both CSI-RS measurements and CSI-RS interpolations and/or extrapolations.

As shown in FIG. 5, the codebook bases may be represented by dₛ and may be based at least in part on a Doppler range corresponding to a Doppler spectrum of a channel between the UE 120 and a network entity (e.g., network entity 601). In example 500, the Doppler range is from f_{Dmin} to f_{Dmax}. The UE 120 may select f_{Dmin} and f_{Dmax} using one or more rules (e.g., a table, a formula, and/or another type of algorithm) stored in a memory of the UE 120 (e.g., according to 3GPP specifications and/or another standard). For example, the UE 120 may perform one or more measurements of the channel and use the rule(s) to determine f_{Dmin} and f_{Dmax} based on the measurement(s). Additionally, or alternatively, the network entity 601 may indicate f_{Dmin} and f_{Dmax} to the UE 120 (e.g., using RRC signaling, a MAC control element (MAC-CE), and/or downlink control information (DCI)). In a combinatory example, the network entity 601 may indicate which rule, of a plurality of rules stored in a memory of the UE 120 120 (e.g., according to 3GPP specifications and/or another standard), to use.

As further shown in FIG. 5, the network entity 601 may indicate a quantity of bases (e.g., represented by D) for the codebook. Accordingly, each column is associated with a bin width represented by Δf_{D}=f_{Dmax}−f_{Dmin}/D. In order to increase the Doppler domain granularity of the CSI report from the UE 120, the network entity 601 may configure a quantity of bases D that is larger than a total quantity of bins N₄. Accordingly, the network entity 601 may configure a non-orthogonal codebook for CSI in a time domain.

As shown in FIG. 5, the network entity 601 may indicate a basis length (e.g., represented by N₄) for the codebook. As described in connection with FIG. 6, the network entity 601 may indicate the basis length directly or indirectly. Accordingly, each row is associated with a bin size (or bin length) represented by ΔT (also referred to as a “subtime” for the codebook). The bin size may be represented in slots (e.g., one slot, two slots, and so on). As used herein, “slot” may refer to a portion of a subframe, which in turn may be a fraction of a radio frame within an LTE, 5G, or other wireless communication structure. In some aspects, a slot may include one or more symbols. Additionally, “symbol” may refer to an OFDM symbol or another similar symbol within a slot. The network entity 601 may further indicate the bin size for the codebook.

Additionally, the codebook may be DFT-based. Accordingly, the UE 120 may determine each entry in the codebook according to e^{j2πft}, where f represents a column associated with the entry (e.g., represented by f=f_{Dmin}+[0, 1, . . . , D−1]·Δf_{D}) and t represents a row associated with the entry (e.g., represented by t=[0, 1, . . . , N₄−1]. ΔT). Although described using the form e^{j2πft}, other DFT-based expressions may be used to determine the entries in the codebook.

By using techniques as described in connection with FIG. 5, the UE 120 uses the codebook to reduce a size of a corresponding CSI report transmitted to the network entity 601 (and thus reduce network overhead associated with the CSI report). Additionally, the UE 120 increases accuracy of the CSI report by using the non-orthogonal codebook while conserving power and processing resources at the network entity 601 and the UE 120 that would otherwise have been used to transmit and receive, respectively, additional CSI-RSs.

As indicated above, FIG. 5 is provided as an example. Other examples may differ from what is described with respect to FIG. 5.

FIG. 6 is a diagram illustrating an example 600 associated with configuring a non-orthogonal DFT codebook for CSI in a time domain, in accordance with the present disclosure. As shown in FIG. 6, a network entity 601 and a UE 120 may communicate with one another (e.g., on a wireless network, such as wireless network 100 of FIG. 1). In some aspects, the network entity 601 may include an RU 340 communicating wirelessly with the UE 120. Additionally, or alternatively, the network entity 601 may include a CU 310 and/or a DU 330 controlling the RU 340 that communicates wirelessly with the UE 120.

As shown by reference number 605, the network entity 601 may transmit, and the UE 120 may receive, a configuration associated with a non-orthogonal DFT codebook (e.g., as described in connection with FIG. 5) for CSI in a time domain. In some implementations, the configuration may indicate a quantity of bases (e.g., represented by D) for the codebook and a basis length (e.g., represented by N₄) for the codebook. Additionally, the configuration may indicate a bin size (e.g., represented by ΔT) for the codebook. Accordingly, each basis (e.g., represented by dₛ) may be associated with a bin width

$$Δ {f}_{D} = \frac{1}{D Δ T} .$$

Therefore, the UE 120 may determine each basis according to an equation of the form

$${d}_{s} = {[ 1 , {e}^{j 2 π \frac{s}{D}} , … , {e}^{j 2 π \frac{s ( {N}_{4} - 1 )}{D}} ]}^{T} ,$$

where s=0, 1, . . . , D.

In some aspects, the configuration may instead indicate an oversampling factor (e.g., represented by O₄) for the codebook. For example, O₄ may be an integer, and O₄>1. Accordingly, a quantity of bases (e.g., represented by D) for the codebook may be based on the oversampling factor and the basis length (e.g., D=N₄O₄). Additionally, the configuration may indicate a bin size (e.g., represented by ΔT) for the codebook. Accordingly, each basis (e.g., represented by dₛ) may be associated with a bin width

$$Δ {f}_{D} = \frac{1}{{N}_{4} {O}_{4} Δ T} .$$

Therefore, the UE 120 may determine each basis according to bin width an equation of the form

$${d}_{s} = {[ 1 , {e}^{j 2 π \frac{s}{{N}_{4} {O}_{4}}} , … , {e}^{j 2 π \frac{s ( {N}_{4} - 1 )}{{N}_{4} {O}_{4}}} ]}^{T} ,$$

where s=0, 1, . . . , D.

In some aspects, the network entity 601 may indicate that the UE 120 should use a subset of a set of bases in the codebook. For example, the UE 120 may select values for s that do not include all integers 0, 1, . . . , S−1. Accordingly, the network entity 601 may include, in the configuration, an indication of a selected subset of bases from the set of bases in the codebook. For example, the network entity 601 may indicate integer values of s for the UE 120 to use to determine the set of bases based on the indicated indices s for each basis dₛ.

In aspects where the network entity 601 indicates an oversampling factor, the network entity 601 may indicate a selected oversampling group of the codebook (e.g., represented by q₄ and selected from integers {0, 1, . . . , O₄−1}) and indicate a selected subset of bases (e.g., represented by n₄^{(s)}, where each value of n₄ is selected from integers) from a set of bases in the selected oversampling group. For example, the network entity 601 may indicate an integer value for q₄ and one or more integer values for n₄ such that the UE 120 determines the set of bases based on index s=O₄n₄^{(s)}+q₄ for each basis dₛ.

Accordingly, as shown by reference number 610, the network entity 601 may transmit CSI-RS instances using the non-orthogonal DFT codebook. Therefore, the UE 120 may measure the CSI-RS instances and, as shown by reference number 615, generate a CSI report using the non-orthogonal DFT codebook. For example, the CSI report may include a precoding matrix indicator (PMI) and/or another indication of a coefficient matrix (e.g., as described in connection with FIG. 4B) calculated using the non-orthogonal DFT codebook and measurements of the CSI-RS instances. Accordingly, as shown by reference number 620, the UE 120 may transmit, and the network entity 601 may receive, the CSI report. In some aspects, the network entity 601 may therefore use the indicated coefficient matrix to update a precoder (e.g., as described in connection with FIG. 4A) used transmit to the UE 120.

By using techniques as described in connection with FIG. 6, the network entity 601 may configure a non-orthogonal DFT codebook for CSI in a time domain. Accordingly, the UE 120 uses Doppler compression to reduce a size of the corresponding CSI report transmitted to the network entity 601 (and thus reduce network overhead associated with the CSI report). Additionally, the UE 120 increases accuracy of the CSI report by increasing Doppler domain granularity while conserving power and processing resources at the network entity 601 and the UE 120 that would otherwise have been used to transmit and receive, respectively, additional CSI-RSs.

As indicated above, FIG. 6 is provided as an example. Other examples may differ from what is described with respect to FIG. 6.

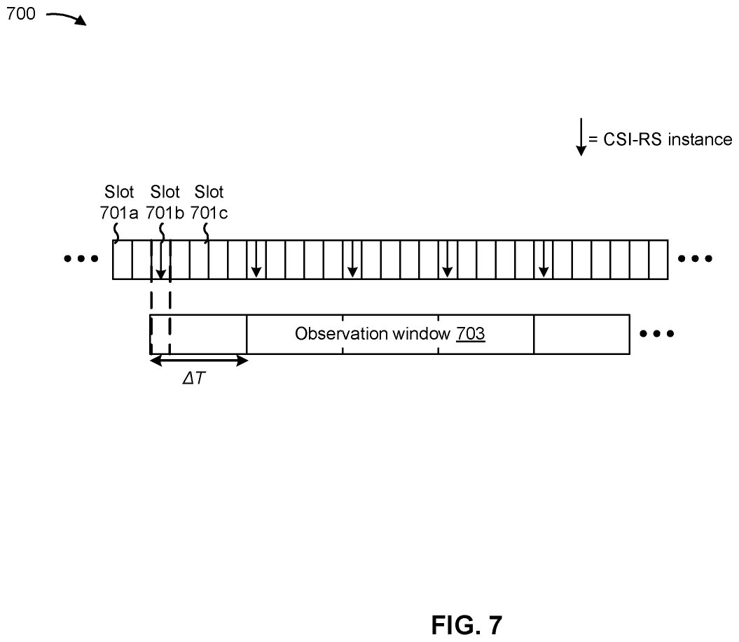

FIG. 7 is a diagram illustrating an example 700 associated with a starting slot for a non-orthogonal DFT codebook for CSI in a time domain, in accordance with the present disclosure. Example 700 shows a plurality of slots (e.g., slots 701a, slot 701b, slot 701c, and so on) along a time domain.

As shown in FIG. 7, a CSI-RS may be transmitted in a first instance in slot 701b and be transmitted in subsequent instances according to an interval. Example 700 includes an interval of five slots, but other examples may use a shorter interval (e.g., four slots, three slots, and so on) or a longer interval (e.g., six slots, seven slots, and so on).

As further shown in FIG. 7, a codebook (e.g., as described in connection with FIG. 5) is associated with a bin size ΔT. Example 700 includes ΔT=5 slots, but other examples may use a shorter bin size (e.g., four slots, three slots, and so on) or a longer bin size (e.g., six slots, seven slots, and so on).

The codebook is further associated with an observation window 703 (e.g., represented by N_{ob}·ΔT). Accordingly, a UE (e.g., the UE 120) may measure the CSI-RS instances included in the observation window 703 and use the measurements and the codebook to determine a CSI report (e.g., as described in connection with FIG. 6). Accordingly, as shown in FIG. 7, a first instance associated with the CSI report is included in slot 701b that corresponds to a first bin of the codebook. Additionally, slot 701b including the first instance is a starting slot for the first bin of the codebook.

As indicated above, FIG. 7 is provided as an example. Other examples may differ from what is described with respect to FIG. 7.

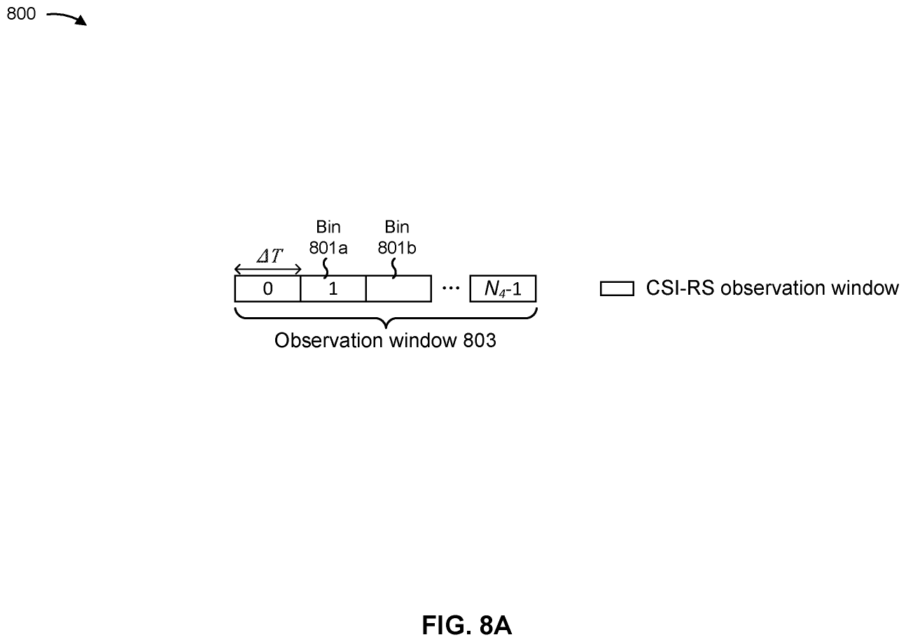

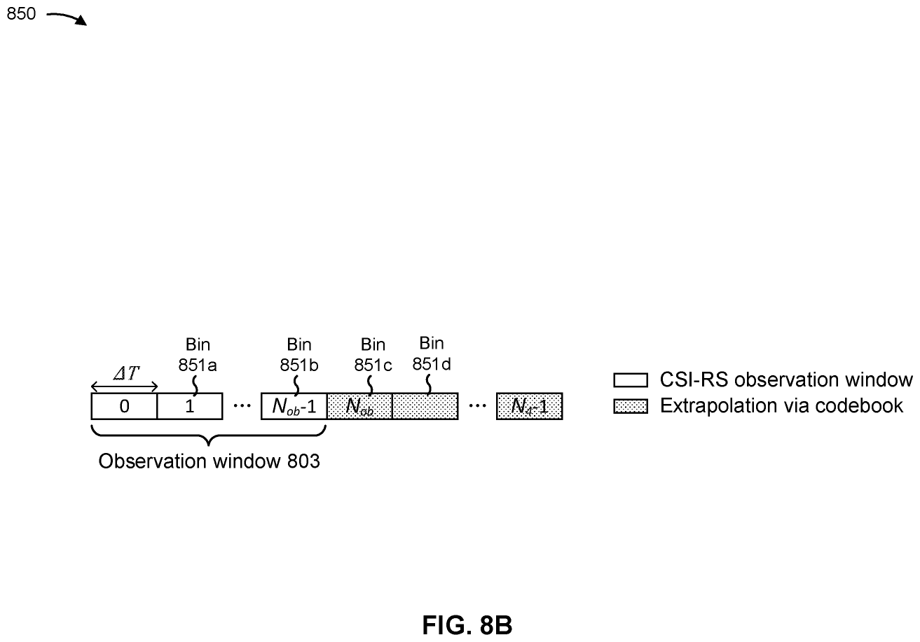

FIGS. 8A and 8B are diagrams illustrating examples 800 and 850, respectively, associated with an observation window for a non-orthogonal DFT codebook for CSI in a time domain, in accordance with the present disclosure. Example 800 includes a plurality of bins (e.g., bin 801a, bin 801b, and so on) for a codebook (e.g., as described in connection with FIG. 5). Each bin may include one or more slots and have a bin size ΔT, and the codebook may be associated with a basis length N₄. As shown in FIG. 8A, an observation window 803 associated with the codebook may span the entire basis length. Accordingly, the observation window 803 may be represented by N₄·ΔT. Therefore, a UE (e.g., UE 120) only uses CSI-RS observations when generating a CSI report using the codebook.

Alternatively, as shown in FIG. 8B, the codebook may include a plurality of bins (e.g., bin 851a, bin 851b, bin 851c, and bin 851d), where a portion of the bins (e.g., bins 851c and 851d in example 850) are associated with extrapolation rather than observation. Accordingly, the observation window 803 may be represented by N_{ob}·ΔT, and N₄>N_{ob}. Therefore, a UE (e.g., UE 120) uses both CSI-RS observations and extrapolations when generating a CSI report using the codebook.

As indicated above, FIGS. 8A and 8B are provided as examples. Other examples may differ from what is described with respect to FIGS. 8A and 8B.

FIGS. 9A, 9B, and 9C are diagrams illustrating examples 900, 910, and 920, respectively, associated with CSI-RS instances for a non-orthogonal DFT codebook for CSI in a time domain, in accordance with the present disclosure.

Example 900 of FIG. 9A shows a plurality of slots (e.g., slots 901a, slot 901b, slot 901c, and so on) along a time domain. As further shown in FIG. 9A, a CSI-RS may be transmitted in a first instance in slot 901b and be transmitted in subsequent instances according to an interval. Example 700 includes an interval of five slots, but other examples may use a shorter interval (e.g., four slots, three slots, and so on) or a longer interval (e.g., six slots, seven slots, and so on).

As shown in FIG. 9A, a codebook (e.g., as described in connection with FIG. 5) is associated with a bin size ΔT. Example 900 includes ΔT=5 slots, but other examples may use a shorter bin size (e.g., four slots, three slots, and so on) or a longer bin size (e.g., six slots, seven slots, and so on).

The codebook is further associated with an observation window 903 (e.g., represented by N_{ob}·ΔT). Accordingly, a UE (e.g., the UE 120) may measure the CSI-RS instances included in the observation window 903 and use the measurements and the codebook to determine a CSI report (e.g., as described in connection with FIG. 6). As shown in FIG. 9A, each bin of the codebook (and thus within the observation window 903) includes at least one CSI-RS instance.

Additionally, in some aspects, each bin of the codebook (and thus within the observation window 903) may include a same quantity of CSI-RS instances. In example 900, each bin includes one CSI-RS instance, but other examples may include additional instances (e.g., two CSI-RS instances, three CSI-RS instances, and so on) per bin of the codebook. Alternatively, each bin may include a single CSI-RS instance, as shown in FIG. 9A.

In aspects where at least some bins include multiple CSI-RS instances, the different CSI-RSs may be associated with a same interval. Accordingly, if example 900 were to include multiple CSI-RS instances per bin, each CSI-RS may be associated with an interval of 5 slots. Alternatively, as shown in example 910 of FIG. 9B, different CSI-RSs may be associated with different intervals. Example 910 of FIG. 9B shows a plurality of slots (e.g., slots 911a, slot 911b, slot 911c, and so on) along a time domain and shows the observation window 903 including CSI-RS instances from a first CSI-RS and a second CSI-RS. The first CSI-RS has an interval of five slots, and the second CSI-RS has an interval of ten slots. Accordingly, in some aspects, the different CSI-RSs may have intervals that are integer multiples of each other. Alternatively, the different CSI-RSs may have intervals that are not integer multiples of each other.

Unlike examples 900 and 910, example 920 of FIG. 9C shows a plurality of slots (e.g., slots 921a, slot 921b, slot 921c, and so on) along a time domain and shows the observation window 903 including at least one bit that does not include a CSI-RS instance. Accordingly, the UE 120 uses both CSI-RS observations and interpolations when generating a CSI report using the codebook.

Although shown using a single CSI-RS similarly to example 900, the observation window 903 of example 920 may alternatively include multiple CSI-RSs similarly to example 910. The multiple CSI-RSs may have a same interval, as described above, or may have different intervals, as shown in FIG. 9B.

As indicated above, FIGS. 9A, 9B, and 9C are provided as examples. Other examples may differ from what is described with respect to Figs. FIGS. 9A, 9B, and 9C.

FIG. 10 is a diagram illustrating an example process 1000 performed, for example, by a UE, in accordance with the present disclosure. Example process 1000 is an example where the UE (e.g., UE 120 and/or apparatus 1200 of FIG. 12) performs operations associated with using non-orthogonal DFT codebooks for CSI signals.

As shown in FIG. 10, in some aspects, process 1000 may include receiving a configuration associated with a non-orthogonal DFT codebook for CSI in a time domain (block 1010). For example, the UE (e.g., using communication manager 140 and/or reception component 1202, depicted in FIG. 12) may receive a configuration associated with a non-orthogonal DFT codebook for CSI in a time domain, as described herein.

As further shown in FIG. 10, in some aspects, process 1000 may include transmitting a CSI report based at least in part on the non-orthogonal DFT codebook (block 1020). For example, the UE (e.g., using communication manager 140 and/or transmission component 1204, depicted in FIG. 12) may transmit a CSI report based at least in part on the non-orthogonal DFT codebook, as described herein.

Process 1000 may include additional aspects, such as any single aspect or any combination of aspects described below and/or in connection with one or more other processes described elsewhere herein.

In a first aspect, the configuration indicates a quantity of bases for the codebook.

In a second aspect, alone or in combination with the first aspect, the configuration indicates a basis length for the codebook.

In a third aspect, alone or in combination with one or more of the first and second aspects, the basis length is greater than or equal to a quantity of bins with observed CSI-RS instances associated with the CSI report.

In a fourth aspect, alone or in combination with one or more of the first through third aspects, the configuration indicates an oversampling factor, and a quantity of bases for the codebook is based on the basis length and the oversampling factor.

In a fifth aspect, alone or in combination with one or more of the first through fourth aspects, the configuration indicates a bin size for the codebook.

In a sixth aspect, alone or in combination with one or more of the first through fifth aspects, the configuration indicates a selected subset of bases, from a set of bases in the codebook, to use for the CSI report.

In a seventh aspect, alone or in combination with one or more of the first through sixth aspects, the configuration indicates a selected oversampling group of the codebook and a selected subset of bases, from a set of bases in the selected oversampling group, to use for the CSI report.

In an eighth aspect, alone or in combination with one or more of the first through seventh aspects, a first instance associated with the CSI report is included in a slot that corresponds to a first bin of the codebook.

In a ninth aspect, alone or in combination with one or more of the first through eighth aspects, the slot including the first instance is a starting slot for the first bin of the codebook.

In a tenth aspect, alone or in combination with one or more of the first through ninth aspects, an observation window associated with the CSI report has a length equal to a time length for the codebook.

In an eleventh aspect, alone or in combination with one or more of the first through tenth aspects, an observation window associated with the CSI report has a length shorter than a time length for the codebook.

In a twelfth aspect, alone or in combination with one or more of the first through eleventh aspects, each bin of the codebook is associated with at least one instance for the CSI report.

In a thirteenth aspect, alone or in combination with one or more of the first through twelfth aspects, each bin of the codebook is associated with a same quantity of instances for the CSI report.

In a fourteenth aspect, alone or in combination with one or more of the first through thirteenth aspects, each bin of the codebook is associated with a single instance for the CSI report.

In a fifteenth aspect, alone or in combination with one or more of the first through fourteenth aspects, at least one bin of the codebook is associated with no instances for the CSI report.

In a sixteenth aspect, alone or in combination with one or more of the first through fifteenth aspects, CSI-RSs for the CSI report each have a same time interval.

In a seventeenth aspect, alone or in combination with one or more of the first through sixteenth aspects, CSI-RSs for the CSI report include at least a first CSI-RS and a second CSI-RS, and the first CSI-RS has a different time interval than the second CSI-RS.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., network entity 601 and/or apparatus 1300 of FIG. 13) performs operations associated with configuring non-orthogonal DFT codebooks for CSI signals.

As shown in FIG. 11, in some aspects, process 1100 may include transmitting a configuration associated with a non-orthogonal DFT codebook for CSI in a time domain (block 1110). For example, the network entity (e.g., using communication manager 150 and/or transmission component 1304, depicted in FIG. 13) may transmit a configuration associated with a non-orthogonal DFT codebook for CSI in a time domain, as described herein.

As further shown in FIG. 11, in some aspects, process 1100 may include receiving a CSI report based at least in part on the non-orthogonal DFT codebook (block 1120). For example, the network entity (e.g., using communication manager 150 and/or reception component 1302, depicted in FIG. 13) may receive a CSI report based at least in part on the non-orthogonal DFT codebook, as described herein.

Process 1100 may include additional aspects, such as any single aspect or any combination of aspects described below and/or in connection with one or more other processes described elsewhere herein.

In a first aspect, the configuration indicates a quantity of bases for the codebook.

In a second aspect, alone or in combination with the first aspect, the configuration indicates a basis length for the codebook.

In a third aspect, alone or in combination with one or more of the first and second aspects, the basis length is greater than or equal to a quantity of bins with observed CSI-RS instances associated with the CSI report.

In a fourth aspect, alone or in combination with one or more of the first through third aspects, the configuration indicates an oversampling factor, and a quantity of bases for the codebook is based on the basis length and the oversampling factor.

In a fifth aspect, alone or in combination with one or more of the first through fourth aspects, the configuration indicates a bin size for the codebook.

In a sixth aspect, alone or in combination with one or more of the first through fifth aspects, the configuration indicates a selected subset of bases, from a set of bases in the codebook, to use for the CSI report.

In a seventh aspect, alone or in combination with one or more of the first through sixth aspects, the configuration indicates a selected oversampling group of the codebook and a selected subset of bases, from a set of bases in the selected oversampling group, to use for the CSI report.

In an eighth aspect, alone or in combination with one or more of the first through seventh aspects, a first instance associated with the CSI report is included in a slot that corresponds to a first bin of the codebook.

In a ninth aspect, alone or in combination with one or more of the first through eighth aspects, the slot including the first instance is a starting slot for the first bin of the codebook.

In a tenth aspect, alone or in combination with one or more of the first through ninth aspects, an observation window associated with the CSI report has a length equal to a time length for the codebook.

In an eleventh aspect, alone or in combination with one or more of the first through tenth aspects, an observation window associated with the CSI report has a length shorter than a time length for the codebook.

In a twelfth aspect, alone or in combination with one or more of the first through eleventh aspects, each bin of the codebook is associated with at least one instance for the CSI report.

In a thirteenth aspect, alone or in combination with one or more of the first through twelfth aspects, each bin of the codebook is associated with a same quantity of instances for the CSI report.

In a fourteenth aspect, alone or in combination with one or more of the first through thirteenth aspects, each bin of the codebook is associated with a single instance for the CSI report.

In a fifteenth aspect, alone or in combination with one or more of the first through fourteenth aspects, at least one bin of the codebook is associated with no instances for the CSI report.

In a sixteenth aspect, alone or in combination with one or more of the first through fifteenth aspects, CSI-RSs for the CSI report each have a same time interval.

In a seventeenth aspect, alone or in combination with one or more of the first through sixteenth aspects, CSI-RSs for the CSI report include at least a first CSI-RS and a second CSI-RS, and the first CSI-RS has a different time interval than the second CSI-RS.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a reporting component 1208, among other examples.

In some aspects, the apparatus 1200 may be configured to perform one or more operations described herein in connection with FIGS. 5, 6, 7, 8A, 8B, 9A, 9B, and 9C. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

In some aspects, the reception component 1202 may receive (e.g., from the apparatus 1206, such as a network entity) a configuration associated with a non-orthogonal DFT codebook for CSI in a time domain. The reporting component 1208 may therefore measure CSI-RSs (e.g., from the apparatus 1206) and generate a CSI report using the non-orthogonal DFT codebook. The reporting component 1208 may include one or more antennas, a modem, a demodulator, a MIMO detector, a receive processor, a controller/processor, a memory, or a combination thereof, of the UE described in connection with FIG. 2. Accordingly, the transmission component 1204 may transmit (e.g., to the apparatus 1206) a CSI report based at least in part on the non-orthogonal DFT codebook.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network entity, or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include a precoding component 1308, among other examples.

In some aspects, the apparatus 1300 may be configured to perform one or more operations described herein in connection with FIGS. 5, 6, 7, 8A, 8B, 9A, 9B, and 9C. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the base station described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the base station described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the base station described in connection with FIG. 2. In some aspects, the transmission component 1304 may be co-located with the reception component 1302 in a transceiver.

In some aspects, the transmission component 1304 may transmit (e.g., to the apparatus 1306, such as a UE) a configuration associated with a non-orthogonal DFT codebook for CSI in a time domain. The precoding component 1308 may therefore precode CSI-RSs using the non-orthogonal DFT codebook for CSI. The precoding component 1308 may include a modem, a modulator, a transmit MIMO processor, a transmit processor, a controller/processor, a memory, or a combination thereof, of the base station described in connection with FIG. 2. Accordingly, the reception component 1302 may receive (e.g., from the apparatus 1306) a CSI report based at least in part on the non-orthogonal DFT codebook.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a user equipment (UE), comprising: receiving a configuration associated with a non-orthogonal discrete Fourier transform (DFT) codebook for channel state information (CSI) in a time domain; and transmitting a CSI report based at least in part on the non-orthogonal DFT codebook.
Aspect 2: The method of Aspect 1, wherein the configuration indicates a quantity of bases for the codebook.
Aspect 3: The method of any of Aspects 1 through 2, wherein the configuration indicates a basis length for the codebook.
Aspect 4: The method of Aspect 3, wherein the basis length is greater than or equal to a quantity of bins with observed CSI reference signal instances associated with the CSI report.
Aspect 5: The method of any of Aspects 3 through 4, wherein the configuration indicates an oversampling factor, and a quantity of bases for the codebook is based on the basis length and the oversampling factor.
Aspect 6: The method of any of Aspects 1 through 5, wherein the configuration indicates a bin size for the codebook.
Aspect 7: The method of any of Aspects 1 through 6, wherein the configuration indicates a selected subset of bases, from a set of bases in the codebook, to use for the CSI report.
Aspect 8: The method of any of Aspects 1 through 6, wherein the configuration indicates a selected oversampling group of the codebook and a selected subset of bases, from a set of bases in the selected oversampling group, to use for the CSI report.
Aspect 9: The method of any of Aspects 1 through 8, wherein a first instance associated with the CSI report is included in a slot that corresponds to a first bin of the codebook.
Aspect 10: The method of Aspect 9, wherein the slot including the first instance is a starting slot for the first bin of the codebook.
Aspect 11: The method of any of Aspects 1 through 10, wherein an observation window associated with the CSI report has a length equal to a time length for the codebook.
Aspect 12: The method of any of Aspects 1 through 10, wherein an observation window associated with the CSI report has a length shorter than a time length for the codebook.
Aspect 13: The method of any of Aspects 1 through 12, wherein each bin of the codebook is associated with at least one instance for the CSI report.
Aspect 14: The method of Aspect 13, wherein each bin of the codebook is associated with a same quantity of instances for the CSI report.
Aspect 15: The method of Aspect 13, wherein each bin of the codebook is associated with a single instance for the CSI report.
Aspect 16: The method of any of Aspects 1 through 12, wherein at least one bin of the codebook is associated with no instances for the CSI report.
Aspect 17: The method of any of Aspects 1 through 16, wherein CSI reference signals (CSI-RSs) for the CSI report each have a same time interval.
Aspect 18: The method of any of Aspects 1 through 16, wherein CSI reference signals (CSI-RSs) for the CSI report include at least a first CSI-RS and a second CSI-RS, wherein the first CSI-RS has a different time interval than the second CSI-RS.
Aspect 19: A method of wireless communication performed by a network entity, comprising: transmitting a configuration associated with a non-orthogonal discrete Fourier transform (DFT) codebook for channel state information (CSI) in a time domain; and receiving a CSI report based at least in part on the non-orthogonal DFT codebook.
Aspect 20: The method of Aspect 19, wherein the configuration indicates a quantity of bases for the codebook.
Aspect 21: The method of any of Aspects 19 through 20, wherein the configuration indicates a basis length for the codebook.
Aspect 22: The method of Aspect 21, wherein the basis length is greater than or equal to a quantity of bins with observed CSI reference signal instances associated with the CSI report.
Aspect 23: The method of any of Aspects 21 through 22, wherein the configuration indicates an oversampling factor, and a quantity of bases for the codebook is based on the basis length and the oversampling factor.
Aspect 24: The method of any of Aspects 19 through 23, wherein the configuration indicates a bin size for the codebook.
Aspect 25: The method of any of Aspects 19 through 24, wherein the configuration indicates a selected subset of bases, from a set of bases in the codebook, to use for the CSI report.
Aspect 26: The method of any of Aspects 19 through 24, wherein the configuration indicates a selected oversampling group of the codebook and a selected subset of bases, from a set of bases in the selected oversampling group, to use for the CSI report.
Aspect 27: The method of any of Aspects 19 through 26, wherein a first instance associated with the CSI report is included in a slot that corresponds to a first bin of the codebook.
Aspect 28: The method of Aspect 27, wherein the slot including the first instance is a starting slot for the first bin of the codebook.
Aspect 29: The method of any of Aspects 19 through 28, wherein an observation window associated with the CSI report has a length equal to a time length for the codebook.
Aspect 30: The method of any of Aspects 19 through 28, wherein an observation window associated with the CSI report has a length shorter than a time length for the codebook.
Aspect 31: The method of any of Aspects 19 through 30, wherein each bin of the codebook is associated with at least one instance for the CSI report.
Aspect 32: The method of Aspect 31, wherein each bin of the codebook is associated with a same quantity of instances for the CSI report.
Aspect 33: The method of Aspect 31, wherein each bin of the codebook is associated with a single instance for the CSI report.
Aspect 34: The method of any of Aspects 19 through 30, wherein at least one bin of the codebook is associated with no instances for the CSI report.
Aspect 35: The method of any of Aspects 19 through 34, wherein CSI reference signals (CSI-RSs) for the CSI report each have a same time interval.
Aspect 36: The method of any of Aspects 19 through 34, wherein CSI reference signals (CSI-RSs) for the CSI report include at least a first CSI-RS and a second CSI-RS, wherein the first CSI-RS has a different time interval than the second CSI-RS.
Aspect 37: An apparatus for wireless communication at a device, comprising a processor; memory coupled with the processor; and instructions stored in the memory and executable by the processor to cause the apparatus to perform the method of one or more of Aspects 1-18.
Aspect 38: A device for wireless communication, comprising a memory and one or more processors coupled to the memory, the one or more processors configured to perform the method of one or more of Aspects 1-18.
Aspect 39: An apparatus for wireless communication, comprising at least one means for performing the method of one or more of Aspects 1-18.
Aspect 40: A non-transitory computer-readable medium storing code for wireless communication, the code comprising instructions executable by a processor to perform the method of one or more of Aspects 1-18.
Aspect 41: A non-transitory computer-readable medium storing a set of instructions for wireless communication, the set of instructions comprising one or more instructions that, when executed by one or more processors of a device, cause the device to perform the method of one or more of Aspects 1-18.
Aspect 42: An apparatus for wireless communication at a device, comprising a processor; memory coupled with the processor; and instructions stored in the memory and executable by the processor to cause the apparatus to perform the method of one or more of Aspects 19-36.
Aspect 43: A device for wireless communication, comprising a memory and one or more processors coupled to the memory, the one or more processors configured to perform the method of one or more of Aspects 19-36.
Aspect 44: An apparatus for wireless communication, comprising at least one means for performing the method of one or more of Aspects 19-36.
Aspect 45: A non-transitory computer-readable medium storing code for wireless communication, the code comprising instructions executable by a processor to perform the method of one or more of Aspects 19-36.
Aspect 46: A non-transitory computer-readable medium storing a set of instructions for wireless communication, the set of instructions comprising one or more instructions that, when executed by one or more processors of a device, cause the device to perform the method of one or more of Aspects 19-36.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a configuration associated with a non-orthogonal discrete Fourier transform (DFT) codebook for channel state information (CSI) in a time domain; and
transmit a CSI report based at least in part on the non-orthogonal DFT codebook.

2. The apparatus of claim 1, wherein the configuration indicates a quantity of bases for the codebook.

3. The apparatus of claim 1, wherein the configuration indicates a basis length for the codebook.

4. The apparatus of claim 3, wherein the basis length is greater than or equal to a quantity of bins with observed CSI reference signal instances associated with the CSI report.

5. The apparatus of claim 3, wherein the configuration indicates an oversampling factor, and a quantity of bases for the codebook is based on the basis length and the oversampling factor.

6. The apparatus of claim 1, wherein the configuration indicates a bin size for the codebook.

7. The apparatus of claim 1, wherein the configuration indicates a selected subset of bases, from a set of bases in the codebook, to use for the CSI report.

8. The apparatus of claim 1, wherein the configuration indicates a selected oversampling group of the codebook and a selected subset of bases, from a set of bases in the selected oversampling group, to use for the CSI report.

9. The apparatus of claim 1, wherein a first instance associated with the CSI report is included in a slot that corresponds to a first bin of the codebook.

10. The apparatus of claim 9, wherein the slot including the first instance is a starting slot for the first bin of the codebook.

11. The apparatus of claim 1, wherein an observation window associated with the CSI report has a length equal to a time length for the codebook.

12. The apparatus of claim 1, wherein an observation window associated with the CSI report has a length shorter than a time length for the codebook.

13. The apparatus of claim 1, wherein each bin of the codebook is associated with at least one instance for the CSI report.

14. The apparatus of claim 13, wherein each bin of the codebook is associated with a same quantity of instances for the CSI report.

15. The apparatus of claim 13, wherein each bin of the codebook is associated with a single instance for the CSI report.

16. The apparatus of claim 1, wherein at least one bin of the codebook is associated with no instances for the CSI report.

17. The apparatus of claim 1, wherein CSI reference signals (CSI-RSs) for the CSI report each have a same time interval.

18. The apparatus of claim 1, wherein CSI reference signals (CSI-RSs) for the CSI report include at least a first CSI-RS and a second CSI-RS, wherein the first CSI-RS has a different time interval than the second CSI-RS.

19. An apparatus for wireless communication at a network entity, comprising:
a memory; and
one or more processors, coupled to the memory, configured to:
transmit a configuration associated with a non-orthogonal discrete Fourier transform (DFT) codebook for channel state information (CSI) in a time domain; and
receive a CSI report based at least in part on the non-orthogonal DFT codebook.

20. The apparatus of claim 19, wherein the configuration indicates a quantity of bases for the codebook.

21. The apparatus of claim 19, wherein the configuration indicates a basis length for the codebook.

22. The apparatus of claim 21, wherein the basis length is greater than or equal to a quantity of bins with observed CSI reference signal instances associated with the CSI report.

23. The apparatus of claim 21, wherein the configuration indicates an oversampling factor, and a quantity of bases for the codebook is based on the basis length and the oversampling factor.

24. The apparatus of claim 19, wherein the configuration indicates a bin size for the codebook.

25. The apparatus of claim 19, wherein the configuration indicates a selected subset of bases, from a set of bases in the codebook, to use for the CSI report.

26. The apparatus of claim 19, wherein the configuration indicates a selected oversampling group of the codebook and a selected subset of bases, from a set of bases in the selected oversampling group, to use for the CSI report.

27. The apparatus of claim 19, wherein a first instance associated with the CSI report is included in a slot that corresponds to a first bin of the codebook.

28. The apparatus of claim 27, wherein the slot including the first instance is a starting slot for the first bin of the codebook.

29. A method of wireless communication performed by a user equipment (UE), comprising:
receiving a configuration associated with a non-orthogonal discrete Fourier transform (DFT) codebook for channel state information (CSI) in a time domain; and
transmitting a CSI report based at least in part on the non-orthogonal DFT codebook.

30. A method of wireless communication performed by a network entity, comprising:
transmitting a configuration associated with a non-orthogonal discrete Fourier transform (DFT) codebook for channel state information (CSI) in a time domain; and
receiving a CSI report based at least in part on the non-orthogonal DFT codebook.
